(19) United States
(12) Patent Application Publication
(10) Pub. No.: US 2008/0155412 A1
(43) Pub. Date: Jun. 26, 2008

(54) Quick reference card and on-line help for a computing system

(75) Inventor: Todd R. Headrick, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/642,445

(22) Filed: Dec. 20, 2006

(51) Int. Cl. G06F 3/00

(52) U.S. Cl. 715/712

(57) ABSTRACT

Various technologies for generating a quick reference card. In one implementation, system settings information about a computing system may be read. Optional settings information about the computing system may then be queried and received thereafter. The system settings information and the optional settings information may then be displayed on the quick reference card.

### BACKGROUND

When computing systems, consumer electronics and the like are purchased, instruction manuals and on-line help are typically provided to give instructions for installation and use. The instruction manuals may typically be printed media with generic information. The instruction manuals may pertain to a large class of products or a generalized group of users. In addition, the instruction manuals may be lengthy. Likewise, when providing help on a topic, the typical on-line help may provide generalized help. For example, the typical on-line help may instruct a user in a manner such as, “ENTER A <PRINTERNAME>.” In this manner, the on-line help assumes that the user has assigned a printer name on the system and that the user remembers the printer name. Unfortunately, such generic instruction manuals and generic on-line help can often be frustrating to consumers.

### SUMMARY

Described herein are implementations of various technologies for generating a quick reference card. In one implementation, system settings information about a computing system may be read. Optional settings information about the computing system may then be queried and received thereafter. The system settings information and the optional settings information may then be displayed on the quick reference card.

Described herein are also implementations of various technologies for providing on-line help from a computing system. In one implementation, a request for help on a topic may be received. In response, a help documentation file for the topic may be retrieved. The help documentation file may have one or more descriptors configured to identify at least one of system settings information for the computing system and optional settings information about the computing system. The help documentation file may then be displayed.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which various technologies described herein may be incorporated and practiced.

FIG. 2 illustrates a flow diagram of a method for generating a system specific quick reference card in accordance with various implementations of the technologies described herein.

FIG. 3 illustrates a quick reference card in accordance with implementations of various technologies described herein.

FIG. 4 illustrates a flow diagram of a method for providing system specific on-line help in accordance with various implementations of the technologies described herein.

FIG. 5 illustrates a help documentation file in accordance with implementations of various technologies described herein.

### DETAILED DESCRIPTION

In general, one or more implementations of various technologies described herein are directed to generating a quick reference card using a quick reference card program module. In one implementation, the quick reference card program module may be configured to read system settings information defined by the computer system and the user during set up. In another implementation, the quick reference card program module may be configured to prompt the user for optional settings information. The quick reference card program module may then generate a quick reference card using the system settings information and the optional settings information. One or more implementations of various technologies described herein are also directed to providing on-line help using an on-line help program module. In one implementation, the on-line help program module may be configured to read and include system settings information and the optional settings information in the help documentation file. The various implementations will be described in more detail in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

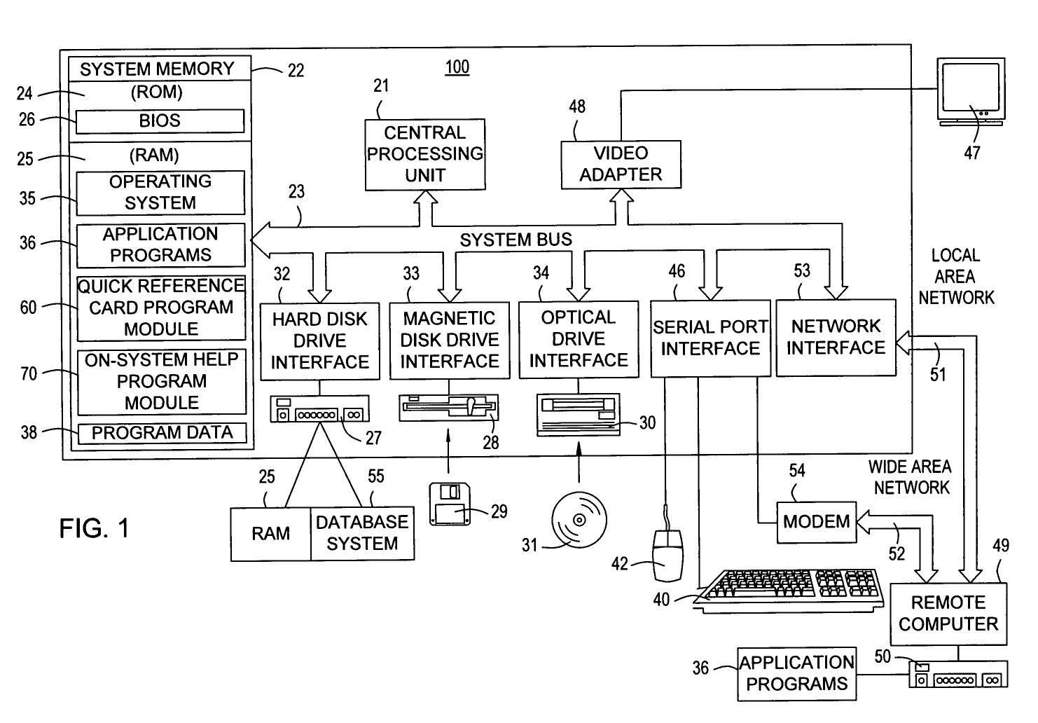

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

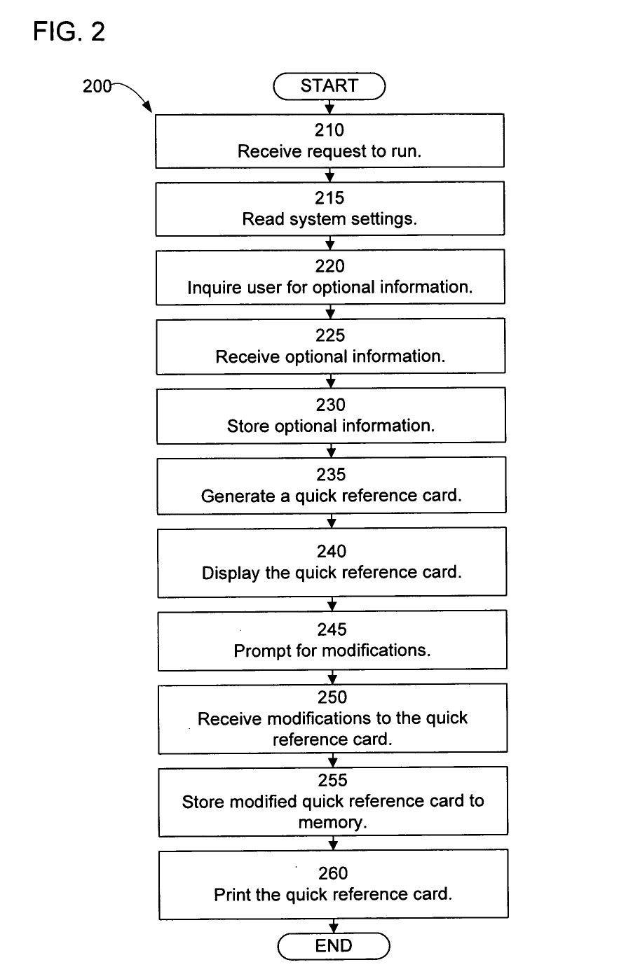

A number of program modules may be stored on the hard disk, magnetic disk 29, optical disk 31, ROM 24 or RAM 25, including an operating system 35, one or more application programs 36, a quick reference card program module 60, an on-line help program module 70, program data 38 and a database system 55. The operating system 35 may be any suitable operating system that may control the operation of a networked personal or server computer, such as Windows® XP, Mac OS® X, Unix-variants (e.g., Linux® and BSD®), and the like. The quick reference card program module 60 and the on-line help program module 70 will be described in more detail with reference to FIGS. 2-5 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for generating a system specific quick reference card in accordance with various implementations of the technologies described herein. In one implementation, the quick reference card program module 60 may be configured to perform the steps described with reference to method 200. It should be understood that while the operational flow diagram of the method 200 indicates a particular order of execution of the operations, in some implementations, the operations might be executed in a different order.

At step 210, the quick reference card program module 60 may receive a request for execution of method 200. At step 215, the quick reference card program module 60 may read various system settings determined during set up. In one implementation, the system settings may include information defined by the computing system 100, such as the internet protocol (IP) address and the like. In another implementation, the system settings may include information defined by the user, such as the server name, personal computer names, user names, shared folder names, internet remote access name and the like. Although the system settings are described here as information determined during set up, it should be understood that the system settings may be determined at times following the set up time.

At step 220, the quick reference card program module 60 may query the user for optional settings information, such as a technical emergency phone number, accessory hardware (e.g., a video game console, a network music player and the like) connected to the computing system 100 and the like. It should be noted that if the quick reference card program module 60 has been executed previously, stored optional settings information may be included in the inquiry such that the user may accept the stored optional settings information rather than entering new information. At step 225, the quick reference card program module 60 may receive the optional settings information. At step 230, the quick reference card program module 60 may store the optional settings information in memory. For example, a table may be maintained to store the user specified values.

At step 235, the quick reference card program module 60 may generate a quick reference card. The quick reference card may have a standard format with general information as well as information read from the system settings and the optional settings information received from the user.

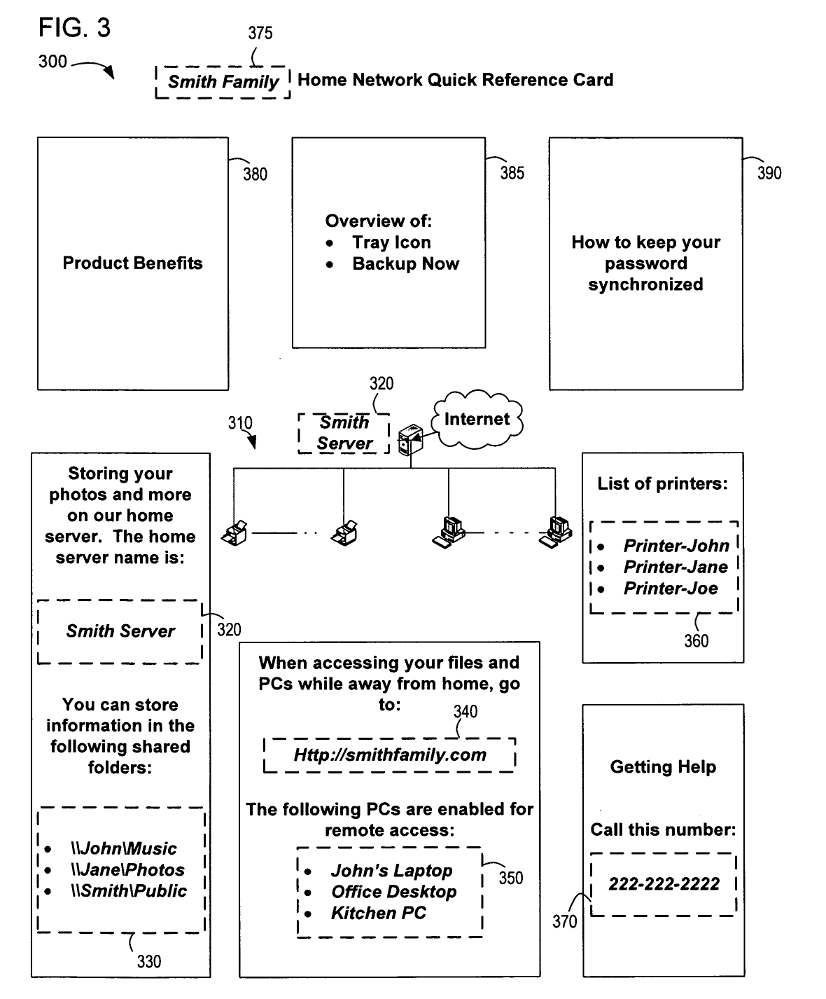

FIG. 3 illustrates a quick reference card 300 in accordance with implementations of various technologies described herein. For purposes of illustration, the information in dash line rectangles represents system settings information or optional settings information. As mentioned above, the system settings information may include information defined by the computer, such as the IP address and information defined by the user, such as the server name, personal computer names, user names, shared folder names, internet remote access name and the like. The optional settings information may include information such as the technical emergency phone number, various accessory hardware (e.g., a video game console, a network music player and the like) connected to the computing system 100 and the like.

For example, the quick reference card 300 may include the server name 320, the shared folder names 330, the internet domain name 340, the personal computer names 350, the printer names 360 and a telephone number for technical emergency 370. The quick reference card 300 may further include a schematic diagram 310 of the specific computing system executing the quick reference card program module 60. The schematic diagram 310 may display a server, one or more printers, one or more personal computers and various computerized devices connected to the server.

The quick reference card 300 may also include a quick reference card title 375, a description of product benefits 380, various overviews 385, and instructions to synchronize passwords 390. Although the quick reference card 300 is illustrated in a particular format in FIG. 3, it should be understood that the quick reference card 300 may include any information pertaining to the computing system 100 and be configured in any format.

Referring back to FIG. 1, at step 240, the quick reference card 300 may be displayed, e.g., on the monitor 47. At step 245, the quick reference card program module 60 may prompt the user for modifications to the quick reference card 300. The modifications may include removing text, adding text, reformatting and the like. At step 250, the quick reference card program module 60 may receive the modifications to the quick reference card 300. At step 255, the modifications may be stored to memory. At step 260, the quick reference card program module 60 may print the quick reference card 300. In one implementation, the quick reference card program module 60 may automatically print the quick reference card 300 when the modifications are stored to memory. In another implementation, the quick reference card program module 60 may print the quick reference card 300 after receiving a request to print from the user. In yet another implementation, the stored quick reference card 300 may be printed at a later time without re-executing the quick reference card program module 60. However, if changes occur in the system or modifications to the quick reference card are desired, the quick reference card program module 60 may be executed as often and as many times as may be desired.

Although method 200 has been described with reference to a computing system, it should be understood that in some implementations method 200 may be used with any computerized device, such as microwaves, radios, digital media devices and the like.

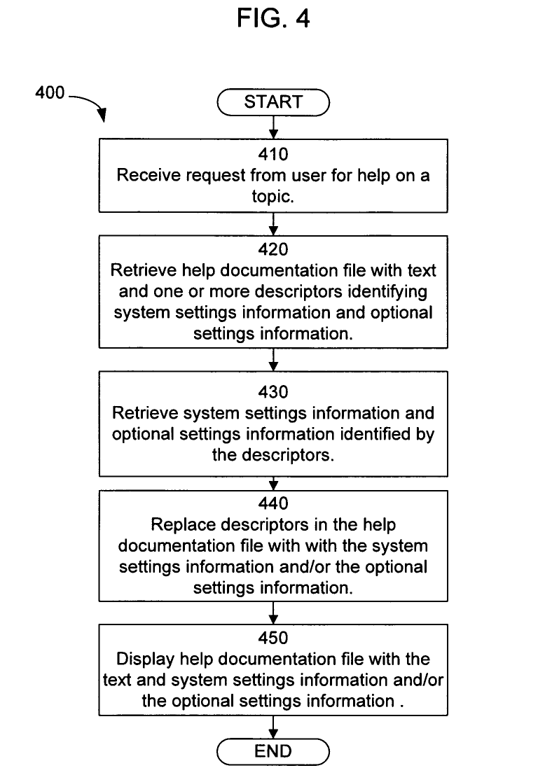

As briefly mentioned above, one or more implementations of various technologies described herein are also directed to providing on-line help, which may be provided via the Internet or from the computing system itself. Providing help from the computing system may be referred to as on-system help. FIG. 4 illustrates a flow diagram of a method 400 for providing on-line help in accordance with various implementations of the technologies described herein. Although various implementations of method 400 are described with reference to on-system help, it should be understood that in some implementations method 400 may be used for any type of on-line help. In one implementation, the on-line help program module 70 may be configured to perform the steps described with reference to method 400. It should be understood that while the operational flow diagram of method 400 indicates a particular order of execution of the operations, in some implementations, the operations might be executed in a different order.

At step 410, the on-line help program module 70 may receive a request for help on a topic. In response, at step 420, the on-line help program module 70 may retrieve a help documentation file directed to the topic. The help documentation file may include both text and one or more descriptors. A descriptor may be defined as an index term, such as a word, phrase or the like, used to identify a record such as a system setting or optional setting in a database or memory. As an example, <PRINTER NAME 1> may be a descriptor identifying the system setting information naming a first printer such as “Printer-John”.

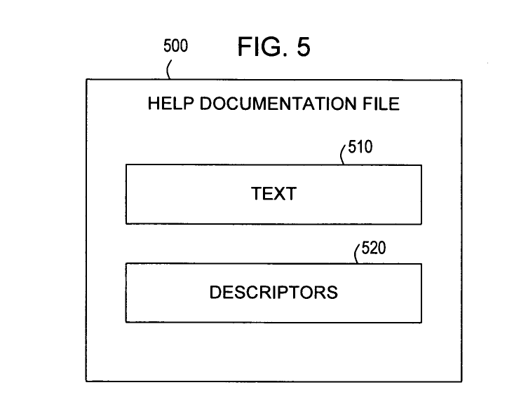

FIG. 5 illustrates a help documentation file 500 in accordance with implementations of various technologies described herein. The help documentation file 500 may include text 510 regarding a particular topic and one or more descriptors 520. The descriptors 520 may identify system settings information determined during set up. As previously mentioned, the system settings may include information defined by the computing system 100, such as the IP address. As another example, the system settings may include information defined by the user, such as the personal computer names, user names, shared folder names, internet remote access name and the like. The descriptors may also identify the optional settings information determined by the quick reference card program module 60. Although the system settings are described herein as information determined during set up, it should be understood that the system settings may be determined at times following the set up time.

At step 430, the on-line help program module 70 may read the identified system settings information from the computing system memory, such as system memory 22. At step 440, the descriptors may be replaced with the system settings information and/or the optional settings information. At step 450, the on-line help program module 70 may display the help documentation file with the text and system settings information and/or the optional settings information in place of the descriptors.

As an example, in response to a request for help, the help documentation file may be typically displayed as follows:
“Type <IP ADDRESS> into the internet address field and <SERVER NAME> into the server name field.”
   In contrast, pursuant to various implementations described herein, the on-line help program module 70 may read the IP address and server name from memory, replace the descriptors in the help documentation file with the IP address and server name and display the help documentation file as follows:
“Type 192.168.2.47 into the internet address field and SmithServer into the server name field.”

Although method 400 has been described with reference to providing on-line help for a computing system, it should be understood that in some implementations, method 400 be used to provide on-line help for other computerized devices, such as microwaves, radios, digital media devices and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for displaying a quick reference card, comprising:
reading system settings information about a computing system;
querying optional settings information about the computing system;
receiving the optional settings information; and
displaying the system settings information and the optional settings information on the quick reference card.

2. The method of claim 1, wherein the system settings information is determined during set up.

3. The method of claim 1, wherein the system settings information comprises information determined by the computing system during set up.

4. The method of claim 1, wherein the system settings information comprises information determined by a user during set up.

5. The method of claim 1, wherein the system settings information comprises internet protocol (IP) address information for the computing system.

6. The method of claim 1, wherein the system settings information comprises at least one of a user-defined name for the computing system, one or more user names having access to the computing system, one or more shared folder names stored in the computing system, an internet remote access name for the computing system, a diagram of the computing system, one or more names for one or more personal computers connected to the computing system and one or more names for one or more printers connected to the computing system.

7. The method of claim 1, wherein the optional settings information comprises at least one of a telephone number for technical emergency and one or more accessory hardware information connected to the computing system.

8. The method of claim 1, further comprising printing the quick reference card.

9. A computer-readable medium having stored thereon computer-executable instructions which, when executed by a computer, cause the computer to:
read system settings information about a computing system, the system settings information being defined by one of the computing system and a user during set up; and
display the system settings information on a quick reference card.

10. The computer-readable medium of claim 9, further comprising computer-executable instructions which, when executed by a computer, cause the computer to:
query optional settings information about the computing system;
receive the optional settings information; and
display the system settings information and the optional settings information on the quick reference card.

11. The computer-readable medium of claim 10, wherein the optional settings information comprises at least one of a telephone number for technical emergency and one or more accessory hardware information connected to the computing system.

12. A memory for storing data for access by an application program being executed on a processor, the memory comprising: a data structure for a quick reference card stored in the memory, the data structure comprising system settings information for a computing system and optional settings information about the computing system.

13. The memory of claim 12, wherein the system settings information comprises information determined by the computing system during set up.

14. The memory of claim 12, wherein the system settings information comprises information determined by a user during set up.

15. The memory of claim 12, wherein the optional settings information comprises at least one of a telephone number for technical emergency and one or more accessory hardware information connected to the computing system.

16. A method for providing on-line help from a computing system, comprising:
receiving a request for help on a topic;
retrieving a help documentation file for the topic, the help documentation file having one or more descriptors configured to identify at least one of system settings information for the computing system and optional settings information about the computing system; and
displaying the help documentation file.

17. The method of claim 16, further comprising retrieving the at least one of the system settings information for the computing system and the optional settings information about the computing system identified by the descriptors.

18. The method of claim 16, further comprising replacing the descriptors with the at least one of the system settings information and the optional settings information.

19. The method of claim 16, further comprising displaying the help documentation file with the at least one of the system settings information and the optional settings information.

20. A memory for storing data for access by an application program being executed on a processor, the memory comprising: a data structure for a help documentation file stored in the memory, the data structure comprising one or more descriptors for identifying at least one of system settings information for a computing system and optional settings information about the computing system.
